(19) United States
(12) Patent Application Publication
(10) Pub. No.: US 2023/0143165 A1
(43) Pub. Date: May 11, 2023

(54) AXLE DEVICE COMPRISING AN ENERGY STORAGE ARRANGEMENT AND A CONVEYING SYSTEM COMPRISING THE AXLE DEVICE

(71) Applicant: Manz AG, Reuttingen (DE)

(72) Inventor: Martin FREUNDT, Esslingen (DE)

(21) Appl. No.: 17/983,614

(22) Filed: Nov. 9, 2022

(30) Foreign Application Priority Data
Nov. 9, 2021 (DE) 10 2021 129 050.3

(51) Int. Cl. B61C 9/00; B61C 3/00

(52) U.S. Cl. CPC B61C 9/00; B61C 3/00

(57) ABSTRACT

An axle device is proposed including a linear shaft, at least one carriage, an electric drive for moving the carriage along the linear shaft, and a mechanical energy storage arrangement. The energy storage arrangement being able to assume a charging state for converting kinetic energy into potential when the carriage is decelerated along the linear shaft energy in an energy charging region, a storage state for storing the potential energy, and a discharging state for converting the stored potential energy into kinetic energy when the carriage is accelerated along the linear shaft in an energy releasing region.

### CROSS-REFERENCE TO RELATED APPLICATIONS

The present application claims priority of DE 10 2021 129 050.3, filed Nov. 9, 2021, the priority of this application is hereby claimed and this application is incorporated herein by reference.

### BACKGROUND OF THE INVENTION

The invention relates to an axle device and to a conveying system comprising at least one such axle device.

Linear shafts are used in industry to passively guide carriages or to actively move carriages along the linear shaft by means of drive motors. Common motors for moving the carriages must be able to achieve both acceleration and deceleration of the carriages. Naturally, in particular for highly dynamic applications, motors with appropriate power must be used for the particular acceleration processes.

One example of such a linear shaft is given, for example, in the publication WO2003070420A1, which is the closest prior art. This publication describes a feeding device for feeding workpiece carriers along a belt conveyor by means of a transporter driven in a controlled manner. The transporter has two shafts, each of which moves a plate for accommodating the component carriers.

### SUMMARY OF THE INVENTION

The object of the present invention is to provide a particularly highly dynamic axle device which is able to cope with a comparatively low motor power.

The subject of the invention is an axle device which is suitable and/or designed in particular for a conveying system. The conveying system is in particular suitable and/or designed for conveying components and/or component holders for components. Thus, the conveying system can convey the components or component holders, optionally together with components, by means of the axle device. In particular, the components can be configured as workpieces. Preferably, the components are elongated, in particular flat. Preferably, the surface of the components is flat. For example, the components can be implemented as plates or strips. The component holders have the function of holding the components such that the components are held by the component holders. Optionally, the components and/or the component holders form part of the conveying system. The component holders can accommodate exactly one component or at least one component.

The axle device comprises at least one linear shaft and at least one carriage, the carriage being guided and/or movable on the linear shaft along the linear shaft. In particular, the carriage carries the component and/or the component holder, for example, by means of a component accommodating portion. Furthermore, the axle device comprises an electric drive which provides the drive torque for moving the carriage on the linear shaft. Particularly preferably, the electric drive is connected to the carriage. In particular, the electric drive comprises at least one electric motor.

As part of the invention, it is proposed that the axle device include a mechanical energy storage arrangement.

The mechanical energy storage arrangement is configured to convert kinetic energy from the carriage into potential energy when the carriage is braked along the linear shaft. This conversion of energy takes place in an energy charging region of the linear shaft, i.e. in a portion of the total length of the linear shaft. A plurality of energy charging regions of this kind can also be provided. During charging, the energy storage arrangement is in a charging state.

Additionally, the energy storage arrangement is configured to store the potential energy in a storage state.

In a discharging state, the energy storage arrangement is configured to convert the stored potential energy into kinetic energy in order to accelerate the carriage along the linear shaft in an energy releasing region of the linear shaft. In particular, the energy storage arrangement functions in parallel with the electric drive.

It is a consideration of the invention that, while it is possible to achieve higher acceleration of the carriage by increasing the size of the electric drive, this also results in an increase in the mass being moved along. Thus, as a result, the efficiency of the increase in size of the electric drive in relation to the desired highly dynamic movement becomes continually worse. In particular, it should not be underestimated that a larger-size electric drive of this kind, together with its corresponding, additional mass, must be additionally accelerated and in particular also decelerated. As a result, heat is generated in the electric drive, and this heat must also be dissipated. Thus, there are physical limits with regard to heat management when designing an axle device of this kind with only an electric drive. In the case of shafts operated by electric motors, the drive train is thus stressed twice: during braking and acceleration. Upon deceleration, the drive must release energy to dissipate the kinetic energy of the moving object, and upon acceleration, the drive must release energy to build up the kinetic energy. For movements which are not continuous and involve frequent speed changes for positioning at discrete points, a significant proportion of the energy that can be provided by the drive is used for acceleration. This results, on the one hand, in “energy consumption” and thus operating costs and, on the other hand, waste heat is released into the environment due to the loss of power from the drives, and the influence of this waste heat on the system must be dealt with, e.g. via active cooling, as part of the engineering of said system. Depending on the design of the drive system, the “energy demand” can be optimized by “energy recovery” and electrical buffering or feeding back into the supply network if the hardware of the drive is capable of feeding back braking power as part of a generator function. However, this is associated with costs and complexity. However, since the drive must continue to “perform”, the heating problem is not reduced; waste heat continues to be generated, and this waste heat is a highly relevant challenge in particular in the case of high-precision machines and can have a major influence on the design and cost structures of the machine.

By contrast, the invention is based on an additional energy storage arrangement which is used in particular in parallel with the electric drive with regard to the kinematics. Instead of actively decelerating the carriage using the electric drive, this negative acceleration is implemented or at least supported by the energy storage arrangement so as to relieve the strain on the electric drive. The extracted kinetic energy is converted into potential energy and stored such that at least little or no kinetic energy is converted into thermal energy. During an acceleration process, the stored potential energy is converted back into kinetic energy such that the strain on the electric drive is also relieved during positive acceleration.

In particular, a parallel drive is proposed, which operates neutrally or almost neutrally in terms of energy but significantly increases the dynamism of the axle device.

In a preferred embodiment of the invention, the carriage is movable in an energy-neutral manner with respect to the stored potential energy in the storage state of the energy storage arrangement. Thus, it is possible to first transfer the energy storage arrangement to the storage state and then move the carriage without changing the stored potential energy. This embodiment is based on the consideration that controlling the electric drive in parallel with the energy storage arrangement is demanding in terms of the control engineering. In particular in situations where, for example, the carriage is decelerated to a standstill, it is complex in terms of control engineering to implement the process of deceleration to a standstill in parallel with the energy storage arrangement and the electric drive. It is far easier to first reduce the kinetic energy of the carriage by means of the energy storage arrangement and to then bring the car to a standstill by means of the electric drive without the influence of the energy storage arrangement. Alternatively or additionally, the electric drive can be used freely without adding or removing potential energy. In particular, this can have the benefit of the electric drive not having to work against the force acting from the potential energy. Thus, in the storage state of the energy storage arrangement, the carriage is alternatively or additionally movable in a force-neutral manner with respect to the stored potential energy.

The storage of the potential energy is to be implemented as simply as possible and in particular mechanically. It is therefore preferred for the potential energy to be stored as gravitational potential energy, with the height position of a weight being changed, in particular independently of the weight of the carriage, such that the potential energy is stored as gravitational potential energy. Alternatively or additionally, it is preferred for the potential energy to be stored as spring energy. Both types of energy storage have the benefit of the storage state being able to be implemented in a manner that is energy-neutral and free of energy loss.

In a preferred embodiment of the invention, the energy storage arrangement includes an energy storage apparatus for storing the potential energy. In particular, the energy storage apparatus operates independently of gravitational potential energy from the carriage. Said energy storage apparatus thus forms an apparatus that is optionally carried along by the carriage but stores the potential energy independently of the carriage.

In the case where the potential energy is in the form of spring energy, the energy storage apparatus can, for example, be configured to be resilient in form; thus, the energy storage apparatus is, for example, configured as a leaf spring, leg spring, coil spring, compression spring, tension spring, etc. Alternatively or additionally, the energy storage apparatus can be configured to be resilient in material; thus, the energy storage apparatus is implemented, for example, as a gas pressure spring, with the spring energy being stored in the compressed gas. A combination of energy storage apparatuses that are resilient in form and material is also conceivable. By means of an energy storage apparatus of this kind, the spring energy can be stored mechanically in a simple manner, permanently and without loss and/or with low loss. In the case where the potential energy is configured as gravitational potential energy, the energy storage apparatus can have a storage mass, the storage mass being shapeless or configured as a body, and the storage mass being changed in height in order to store energy. The height change can be implemented, for example, by means of a gearbox, etc.

In one possible embodiment of the invention, the energy storage apparatus is arranged to be stationary with respect to the linear shaft. Thus, it is provided for the carriage to travel along the linear shaft to the energy storage apparatus, where the kinetic energy is converted into potential energy. The advantage of an arrangement of this kind is that the energy storage arrangement is not transported along with the carriage and thus is not a moving mass.

In an alternative embodiment of the invention, it is provided for the energy storage apparatus to be moved along with the carriage. This embodiment has the advantage that the position of the conversion of kinetic energy into potential energy or in the opposite direction is not fixed by the position of the energy storage apparatus, but can be arranged along the linear shaft as desired and, in particular, at multiple points one after the other. Such an energy storage apparatus that is carried along can be alternately charged and discharged, for example; a cycle of this kind can be provided at multiple points along the linear shaft. In other words, in the case of the energy storage apparatus that is carried along, a plurality of energy charging regions and a plurality of energy releasing regions are arranged along the linear shaft. In particular, the energy storage apparatus is configured to be independent of the potential energy of the carriage.

In one possible embodiment of the invention, the axle device comprises at least one reversal point, the energy charging region being arranged upstream of the reversal point in the direction of movement of the carriage in order to decelerate the carriage upstream of the reversal point such that said carriage reaches the reversal point in a slowed and/or decelerated state. The energy releasing region is arranged downstream of the reversal point in relation to the direction of movement of the carriage in order to accelerate the carriage away from the reversal point. For example, it is possible for the carriage to be decelerated in the energy charging region by the conversion of kinetic energy into potential energy in such a way that said carriage is stopped in the reversal point. Alternatively or additionally, it is possible for the carriage to be accelerated away from a stationary position at the reversal point by the energy storage apparatus, specifically by converting the potential energy into kinetic energy. In this embodiment in particular, it is possible to relieve the strain, in terms of energy, on the region on the movement path of the carriage that requires the most work from the electric drive due to the reversal of the direction of movement.

Alternatively or additionally, the linear shaft has one or more energy storage portions, the energy charging region being arranged at the beginning of the energy storage portion in order to decelerate the carriage, and the energy releasing region being arranged at the end of the energy storage portion in order to accelerate the carriage in the same direction of movement. This makes it possible, for example, to move the carriage to the energy storage portion at high speed and to decelerate the carriage at the beginning of the energy storage portion in an energy-neutral manner such that said carriage passes through the further energy storage portion at reduced speed, for example in order to load or unload the carriage or in order to process a workpiece on the carriage. At the end of the energy storage portion, the carriage is accelerated in the same direction of movement by converting the stored potential energy back into kinetic energy such that the carriage is moved away, in particular in a highly dynamic manner.

In one possible embodiment of the invention, the energy storage arrangement has a carriage partner and a track partner. The partners, i.e. the carriage partner and the track partner, together form a curved track apparatus by means of which the partners move relative to one another. One partner has a curved track, and the other partner has a runner that can run along the curved track. At least one of the partners is operatively connected to the energy storage apparatus, in particular by means of a gearing such that, when the runner runs along the curved track, the energy storage apparatus is charged in an energy charging region and/or discharged in an energy releasing region. For example, it is possible for the runner to be connected to the energy storage apparatus, the runner being forcibly guided via the curved track and, in this way, being able to charge the energy storage apparatus with spring energy. At the same time, it is also possible for the partner with the curved track to be connected to the energy storage apparatus, the curved track being forcibly guided relative to the runner such that, when the curved track runs along the runner, the energy storage apparatus is charged with potential energy.

In a preferred embodiment of the invention, the curved track has an input portion, the input portion being oriented in the same direction as the linear shaft. Alternatively or additionally, the curved track has an output portion, the output portion being oriented in the same direction as the linear shaft. By each portion being oriented in the same direction as the linear shaft, the runner is not displaced relative to the linear shaft in the charging direction thereof such that conversion of kinetic energy into spring energy or in the opposite direction does not occur in this case. In particular, this allows the carriage to move in the output portion (and also in the input portion) in an energy-neutral manner even when the energy storage apparatus is charged.

In one possible embodiment of the invention, the runner has a track roller, the track roller rolling along the curved track. A track roller of this kind reduces the friction in the axle device in the region of the energy storage arrangement. In one possible further development of the invention, it is provided for the track roller to be actively drivable. In particular, the track roller is actively drivable if it is arranged without contact with the curved track. This embodiment is based on the consideration that the track roller must always be initially accelerated when the track roller starts moving relative to the curved track such that the initial acceleration will always cause a starting jolt to pass through the axle device. Since the track roller is actively drivable, said track roller can be pre-accelerated to a speed that corresponds to the subsequent speed when rolling along the curved track so as to avoid the initial jolt.

In a preferred implementation of the invention, the energy storage apparatus comprises a leg spring for storing energy. The leg spring is connected by one leg to one of the partners in a stationary state and by the other leg to the runner. Firstly, the leg spring has the advantage of being able to be integrated particularly cost-effectively. Secondly, the runner on the moving leg describes a circular charging path when said leg is moved relative to the other counter to the spring force, the circular charging path resulting in particularly effective force transmission to the other partner.

In addition, it is particularly preferred for the leg spring or the free leg to be penetratingly inserted into the curved track by means of the runner. The effective force transmission is further improved by the penetrating insertion.

The invention also relates to a conveying system, the conveying system comprising at least one axle device as described above.

The conveying system preferably has a plurality of axle devices, e.g. for transporting component accommodating portions. In particular, the conveying system can have four, five, six or more axle devices with the same design or a different design. In particular, each axle device has at least one or exactly one component accommodating portion. The component accommodating portion forms a mechanical interface for accommodating the exactly one or at least one component or the exactly one or at least one component holder. The component accommodating portion can have members, such as pins, grippers, active members, in particular active grippers or the like, for holding the component and/or the component holder in a positionally defined manner.

The axle devices are preferably designed independently of one another and can each have one or more individual axes, preferably exactly two individual axes for moving and/or manipulating the component accommodating portion. Optionally, the axle device has further axes which, in particular, do not provide a shuttle function but allow fine alignment of the component or component holder in the sense of setting the component position, e.g. “angle adjustment” or “setting straight” or the like, in order to bring the component into the process region of the process unit, in particular of the printing head, in spite of tolerances.

The at least one axle device preferably has the task of transporting the associated component accommodating portion on at least one or exactly one station path along a main transport direction in at least one or exactly one component station. Preferably, the component accommodating portions are transported in a straight line along a main transport direction on the station path. For example, the component station can have a process function and/or a manufacturing function and/or a measurement function. Particularly preferably, the component station has a process unit, the component accommodating portion being transported along the station path at the process unit for processing the component. Particularly preferably, the component accommodating portion is transported continuously along the station path. Possible processes in the component station and/or relating to the process unit are: printing on surfaces of the components; measuring surfaces of the components; digitizing surface structures, colors and properties of the components; other processing, treatment and/or analysis of component surfaces; processing of materials or the components in a continuous or alternatively cyclic mode of operation. Alternatively, the axle device can be used for pick-and-place applications.

Optionally, the conveying system comprises the component station. Optionally, the component station defines a process direction via which the process takes place in the direction of the component or the component accommodating portion.

Preferably, the axle device has a travel length of more than 2 m, preferably more than 3 m, in particular more than 4 m. Particularly preferably, the axle device moves the component accommodating portion in an oscillating and/or reciprocating manner in the main transport direction. In specific embodiments, in particular for pick-and-place applications, the travel length can be less than 0.5 m, in particular less than 0.3 m.

For example, in printing applications, an energy charging region can be formed upstream of a printing section, an energy releasing region can be formed downstream of the printing section, and an energy-neutral region can be formed within the printing section.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIGS. 1 a, b, c are respective schematic views of an axle device as one exemplary embodiment of the invention;

FIG. 2 is a schematic view of an energy storage arrangement for the axle device in the preceding figures;

FIG. 3 is a schematic view of a sequence when the partners of the energy storage arrangement in FIG. 2 are brought together;

FIG. 4 is a schematic view of a further energy storage arrangement for the axle device in the previous figures; and

FIG. 5 is a schematic view of the energy storage arrangement having a driven runner.

### DETAILED DESCRIPTION OF THE INVENTION

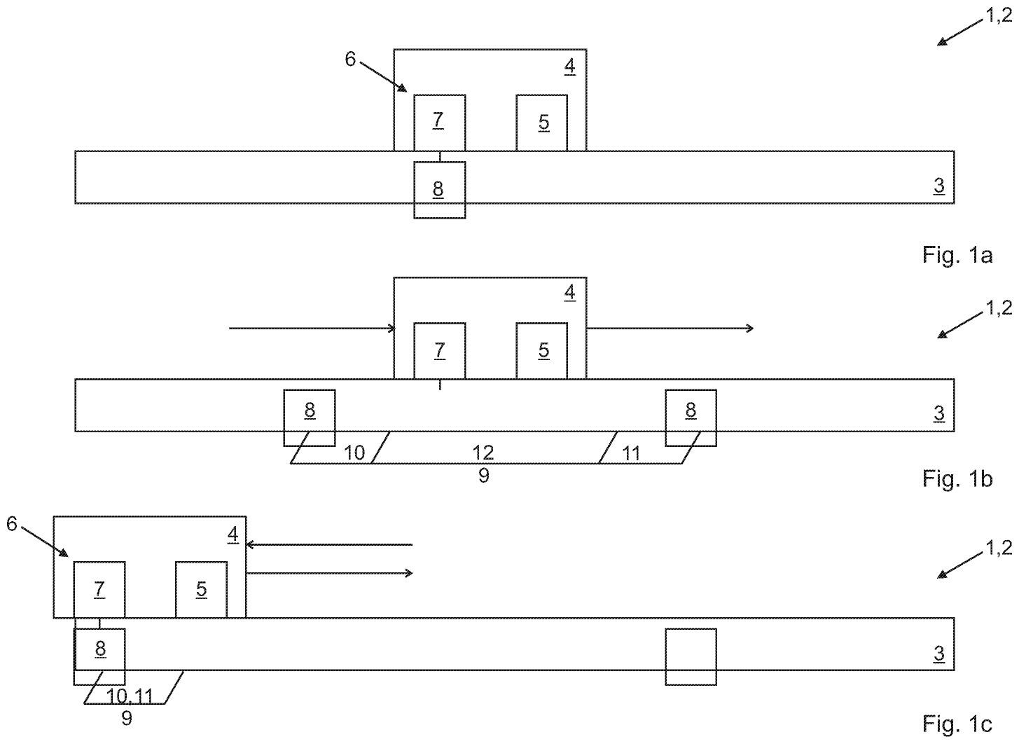

FIGS. 1 a, b, c each show an axle device 1 of a conveying system 2 as one example of the invention. As shown, the conveying system 2 can comprise exactly one axle device 1 or a plurality of axle devices 1. Furthermore, the conveying system 2 can comprise, for example, a processing station, a loading station and/or an unloading station (not shown).

The axle device 1 has a linear shaft 3, the linear shaft 3 being configured, for example, as a rail, in particular a steel rail, or as an aluminum profile, or comprising the same. Furthermore, the axle device 1 comprises a carriage 4, the carriage 4 being arranged so as to be movable on the linear shaft 3 in a direction of movement. The axle device 1 comprises an electric drive 5, the electric drive 5 being arranged on the carriage 4 in this exemplary embodiment in order to be able to actively move said carriage along the linear shaft 3.

The axle device 1 has a mechanical energy storage arrangement 6, which is arranged kinematically in parallel with the electric drive 5. The energy storage arrangement 6 has a carriage partner 7 and a track partner 8, which can interact with one another. The carriage partner 7 is arranged on the carriage 4, and the track partner 8 is arranged on the linear shaft and/or fixed thereto in a stationary state.

The energy storage arrangement 6 has the function of converting kinetic energy from the carriage 4 into potential energy when the carriage 4 is decelerated along the linear shaft 3. In addition, the energy storage arrangement 6 has the function of storing the potential energy. As a further function, the energy storage arrangement 6 can convert stored potential energy or a portion thereof back into kinetic energy and accelerate the carriage 4 along the linear shaft 3 using the converted potential energy. Thus, when the potential energy is discharged, the energy storage arrangement 6 forms a mechanical drive that acts kinematically in parallel with the electric drive 5. It can be provided for the parallel drives to operate entirely or largely in parallel; alternatively, the parallel drives have only parallel force components.

This mechanical parallel drive makes it possible that along the linear shaft 3 in an energy charging region, the carriage 4 being decelerated in the energy charging region to charge the mechanical energy storage arrangement 6 with potential energy. By contrast, in an energy releasing region, the stored potential energy is converted into kinetic energy to accelerate the carriage 4.

FIG. 1b shows a variation of the axle device 1 in FIG. 1a, with an energy storage portion 9 being provided along the linear shaft 3; in this energy storage portion, an energy charging region 10 of this kind is first arranged along the direction of movement of the carriage 4, and an energy releasing region 11 of this kind is arranged at the end of the energy storage portion 9. Functionally, the carriage 4 enters the energy charging region 10 and is decelerated there, with the kinetic energy being converted into the potential energy. In an intermediate region 12 between the energy charging region 10 and the energy releasing region 11, the carriage 4 can be moved through at a reduced speed, for example. Here the energy storage arrangement 6 operates in an energy-neutral and/or passive manner. Subsequently, the carriage 4 enters the energy releasing region 11, with the potential energy or some of the potential energy being released again to accelerate the carriage 4. For example, the processing station or the transfer station is located in the intermediate region 12, with the speed having to be reduced in comparison with the regions outside the energy storage portion 9. The mechanical energy storage arrangement 6 makes it possible to perform deceleration and acceleration in an almost energy-neutral manner. Optionally, the electric drive 5 can actively support the deceleration and/or the acceleration.

FIG. 1c shows the axle device 1 in the preceding figures, with the carriage 4 passing through a reversal point, for example at the end of the linear shaft 3. Upstream of the reversal point, the carriage 4 enters an energy charging region 10 of this kind and is decelerated upstream of the reversal point. Braking can be implemented exclusively mechanically via the energy storage arrangement 6 or alternatively by a combination of mechanical and electromotive deceleration using the electric drive 5. In any case, the speed of the carriage 4 is reduced to zero at the reversal point. For example, at the reversal point, the carriage 4 can be loaded with a workpiece or a workpiece can be unloaded therefrom. Subsequently, the carriage 4 enters an energy releasing region 11 of this kind, with the stored potential energy or some thereof being converted to kinetic energy to accelerate the carriage 4 away from the reversal point. At the reversal point, the energy charging region 10 and the energy releasing region 11 are arranged one after the other in the direction of movement of the carriage but are positioned so as to overlap in relation to the linear shaft 3.

In particular, it is provided for one such track partner 8 of the mechanical energy storage arrangement 6 to be arranged in both the energy charging region 10 and the energy releasing region 11, as shown in FIG. 1b. However, it can be provided for just a single carriage partner 7 to be arranged on the carriage 4.

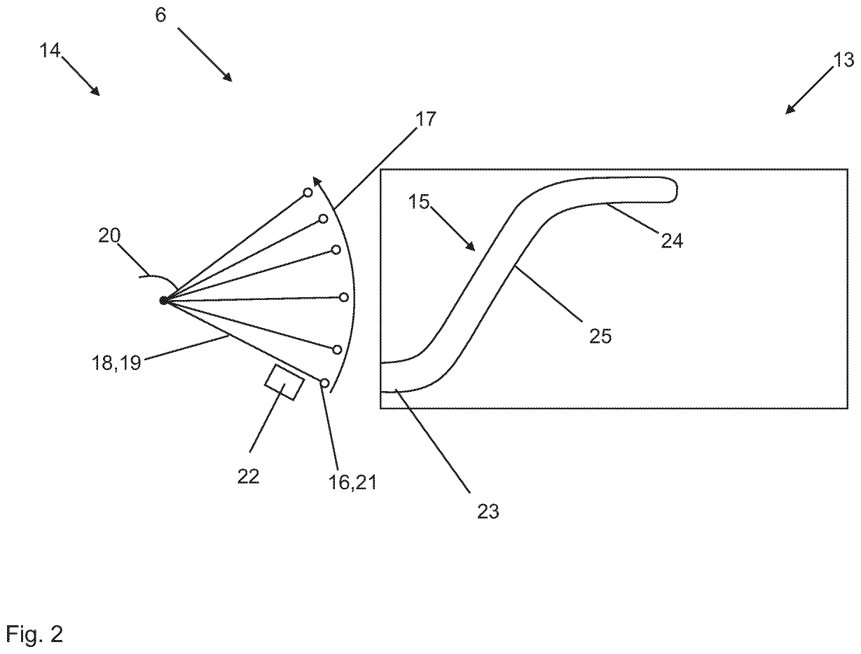

FIG. 2 is a highly schematized view of an exemplary embodiment of the energy storage arrangement 6. The energy storage arrangement 6 has a first partner 13 and a second partner 14. The first partner 13 can be configured as either the carriage partner 7 or the track partner 8. The second partner 14 is accordingly configured as the other.

The first partner 13 has a curved track 15, and the second partner 14 has a runner 16 which is forcibly guided along the curved track 15 during relative movement between the first partner 13 and the second partner 14. The runner 16 is operatively connected to an energy storage apparatus 18 of the energy storage arrangement 6 such that, by means of a forcibly guided movement of the runner 16 along a charging path 17 by the curved track 15, the energy storage apparatus 18 is charged with potential energy in one direction of the charging path 17 and is discharged in the other direction of the charging path 17.

For example, the potential energy can be spring energy. In this exemplary embodiment, the energy storage apparatus 18 is implemented as a leg spring 19. The leg spring 19 is similar to a leaf spring and is connected to a fixed point of the second partner 14 by one leg 20 and to the runner 16 by the other leg 21. When the leg spring 19 is deflected by moving the runner 16 along the track 18, the leg spring 19 is tensioned and thus charged with spring energy and is released in the opposite direction and thus discharged. In FIG. 2, the leg spring 19 is shown several times in various charging states along the charging path 17.

The second partner 14 has a mechanical stop 22 against which the leg spring 19 rests in the rest position and/or released state. The stop 22 is positioned in such a way that the runner 16 is inserted into the curved track 15 in the rest position, in particular without jolting.

The curved track 15 has an input portion 23 and an output portion 24, the input portion 23 and/or the output portion 24 being oriented in the same direction as a direction of movement of the first or the second partner 13, 14. Upon relative movement between the first and second partners 13, 14, the runner 16 enters the input portion 23 and is not initially moved along the charging path 17. Thus, the energy storage arrangement 6 operates in an energy-neutral manner when the carriage 4 moves in the direction of movement. Only in an incline portion 25 between the input portion 23 and the output portion 24 is the runner 16 then moved relative to the fixed point 20 in such a way that said runner moves along the charging path 17 and the leg spring 19 is tensioned in the output portion 24. The output portion is aligned in parallel with the direction of movement of the carriage 4 such that the energy storage arrangement 6 is energy-neutral when the carriage 4 moves in the direction of movement.

For example, considering the situation shown in FIG. 1c at the reversal point, the first partner 13 can be configured as the carriage partner 7, and the second partner 14 can be configured as the track partner 8, for example. In this case, the carriage 4 having the first partner 13 moves towards the second partner 14 and catches the runner 16 by means of the curved track 15. As the carriage 4 continues to move toward the reversal point, the runner 16 travels up the intermediate portion 25, with kinetic energy from the carriage 4 being converted into spring energy of the leg spring 19.

Once the runner 16 has arrived at the output portion 15, no further kinetic energy is converted when the carriage 4 continues to move toward the reversal point. The travel path is then energy-neutral. In addition, the runner 16 is self-retaining in the output portion 15, which is oriented in the same direction as the linear shaft 3, such that no spring energy can be converted into kinetic energy either.

The electric drive 5 can then be used to start the carriage 4 in the opposite direction, with the energy storage arrangement 6 converting spring energy into kinetic energy, but only when the runner 16 has left the output portion 24 and entered the incline portion 25.

For the situation in FIG. 1b, for example, it can be provided for the second partner 14 to be configured as the carriage partner 7. Alternatively, the first partner 13 is connected to the carriage 4. In both cases, the curved track 15 can have a further incline portion 25 downstream of the output portion 24, which, however, is oriented in the opposite direction, leading to a further input portion 23. As soon as the carriage 4 enters the energy storage portion 9, the runner 16 is caught in the input portion 23 in an energy-neutral manner. Subsequently, the carriage 4 enters the energy charging region 10, with the energy storage apparatus being charged with spring energy in the manner already described by passing through the incline portion 25. Subsequently, the energy-neutral output portion 24 follows, and the carriage 4 passes through the intermediate region 12. As soon as the carriage 4 enters the energy releasing region 11, the runner 16 travels down the further incline portion and converts the spring energy into kinetic energy in this way. The runner can then leave the curved track 15 in an energy-neutral manner via the further input portion. If the direction of the carriage 4 is reversed, the energy storage portion 9 can be passed through in the opposite direction.

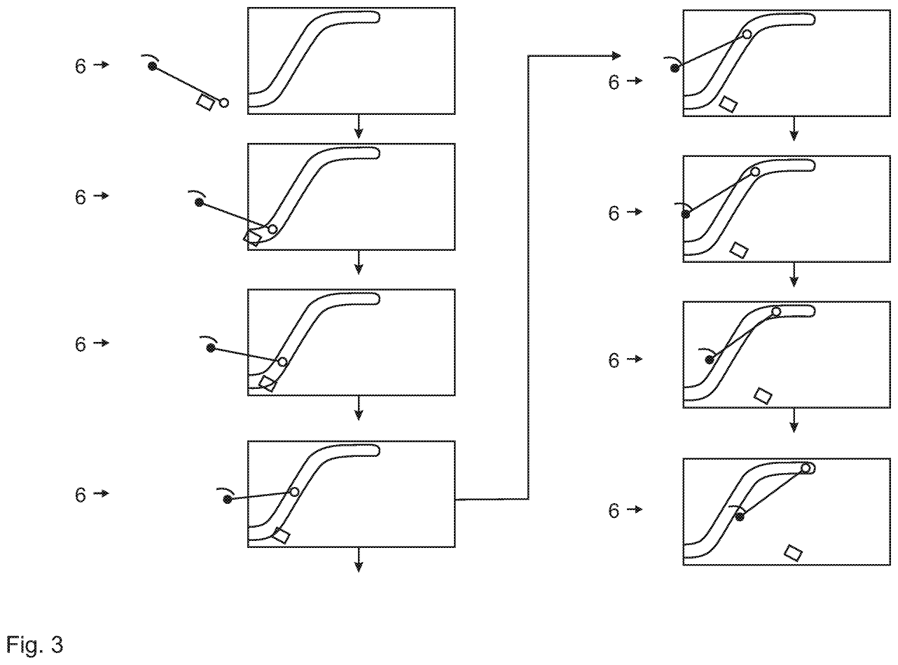

FIG. 3 shows a schematic sequence during the charging of the energy storage arrangement 6. Discharging takes place in the reverse order.

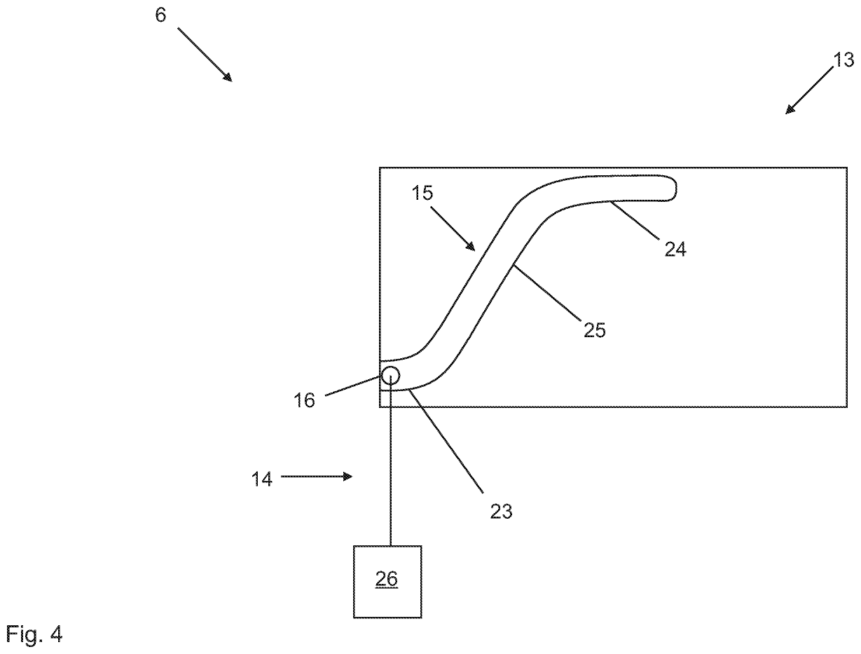

FIG. 4 shows an alternative embodiment for the second partner 14 in the same view as in FIG. 2. In the exemplary embodiment in FIG. 4, the energy storage arrangement 6 uses gravitational potential energy, rather than spring energy, as potential energy. Similarly, the second partner 14 has the runner 16, but in this embodiment, the runner is connected to a weight 26 as an energy storage apparatus 18 such that, in the incline portion 25, the weight 26 is pulled upward, thereby charging the energy storage apparatus 18 with gravitational potential energy. The runner 16 operates as previously described; thus, reference is made to the preceding description.

Instead of a downwardly oriented weight 26, the gravitational potential energy can also be dissipated via a gearing or other structure. Similarly, it is also possible for a compression spring or a tension spring to be used instead of the weight 26 and for the potential energy to be spring energy.

It should also be noted that, in the embodiment example in FIG. 4, the weight force from the weight 26 or the spring force from a similarly configured spring is oriented downward. However, the leg spring 18 in FIG. 2 presses tangentially to the charging path 17 such that the force component in the direction of movement of the carriage 4 is proportionally greater than in the exemplary embodiment in FIG. 4.

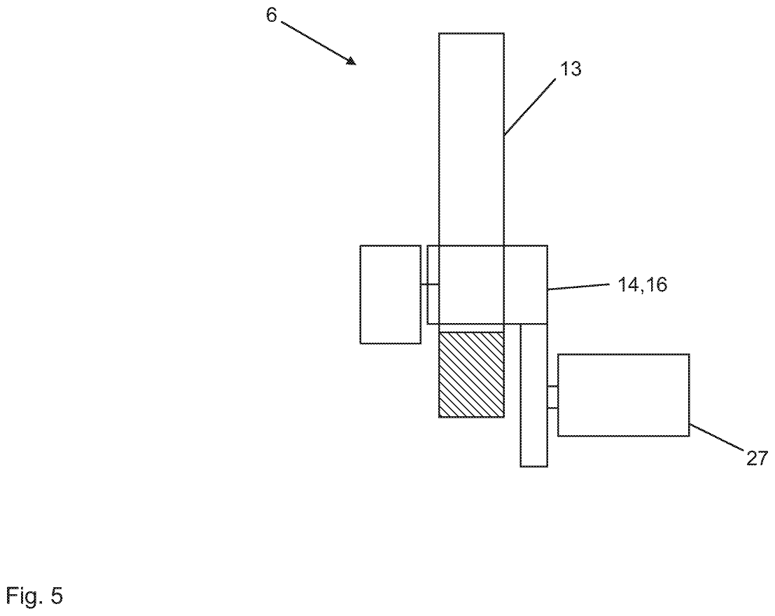

FIG. 5 is a highly schematized view of the energy storage arrangement 6 in the direction of movement, showing the first partner 13 with the curved track 15 and the second partner 14 with the runner 16. The runner 16 is configured as a rotatable roller which can roll along the curved track 15. It is insignificant whether the energy storage apparatus 17 is configured according to the exemplary embodiment in FIG. 2 or FIG. 4 or according to another exemplary embodiment.

The axle device 1, in particular the energy storage arrangement 6, has a drive motor 27, which is configured to rotate the runner 16 prior to contact with the curved track 15 such that no significant relative movement, which generates wear on the roller and the curved track 15, occurs upon contact with the curved track 15.

While specific embodiments of the invention have been shown and described in detail to illustrate the inventive principles, it will be understood that the invention may be embodied otherwise without departing from such principles.

I claim:

1. An axle device, comprising:
a linear shaft;
at least one carriage;
an electric drive for moving the carriage on the linear shaft; and
a mechanical energy storage arrangement, the energy storage arrangement being capable of assuming a charging state for converting kinetic energy into potential energy upon deceleration of the carriage along the linear shaft in an energy charging region, a storage state for storing the potential energy, and a discharging state for converting the stored potential energy into kinetic energy upon acceleration of the carriage along the linear shaft in an energy releasing region.

2. The axle device according to claim 1, wherein, in the storage state of the energy storage arrangement, the carriage can be moved in an energy-neutral manner with respect to the stored potential energy and/or in a force-neutral manner with respect to the energy storage arrangement.

3. The axle device according to claim 1, wherein the potential energy is configured as gravitational potential energy and/or as spring energy.

4. The axle device according to claim 1, wherein the energy storage arrangement comprises at least one energy storage apparatus for storing the potential energy.

5. The axle device according to claim 4, wherein the energy storage apparatus is arranged to be stationary with respect to the linear shaft or in that the energy storage apparatus is moved along with the carriage.

6. The axle device according to claim 1, wherein the axle device has at least one reversal point, the energy charging region being located upstream of the reversal point in order to decelerate the carriage upstream of the reversal point, and the energy releasing region being located downstream of the reversal point in order to accelerate the carriage away from the reversal point.

7. The axle device according to claim 1, wherein the linear shaft comprises an energy storage portion, the energy charging region being arranged at the beginning of the energy storage portion in order to decelerate the carriage, and the energy releasing region being arranged at the end of the energy storage portion in order to accelerate the carriage in the same direction of movement.

8. The axle device according to claim 1, wherein the energy storage arrangement comprises a carriage partner and a track partner, the partners together forming a curved track apparatus by which the partners move relative to one another, one partner having at least or exactly one curved track, and the other partner having a runner, at least one of the partners being operatively connected to the energy storage apparatus such that, when the runner runs on the curved track, the energy storage apparatus is charged in an energy charging region and/or discharged in an energy releasing region.

9. The axle device according to claim 8, wherein the at least or exactly one curved track has an input portion, the input portion being oriented in the same direction as the linear shaft, and/or has an output portion, the output portion being oriented in the same direction as the linear shaft, such that the runner moves in the input portion and output portion in an energy-neutral manner.

10. The axle device according to claim 8, wherein the runner is guided by the curved track along a charging path in a direction transverse to the linear shaft, the runner being operatively connected to the energy storage apparatus in order to charge and/or discharge the energy storage apparatus.

11. The axle device according to claim 1, wherein the runner has a track roller, the track roller rolling on the curved track.

12. The axle device according to claim 11, wherein the track roller is actively drivable.

13. The axle device according to claim 1, wherein the energy storage apparatus has a leg spring for energy storage, the leg spring being connected by one leg to one of the partners in a stationary state and by the other leg to the runner.

14. The axle device according to claim 13, wherein the leg spring is penetratingly inserted into the curved track.

15. A conveying system comprising at least one axle device according to claim 1.
